(19) United States
(12) Patent Application Publication
(10) Pub. No.: US 2013/0163792 A1
(43) Pub. Date: Jun. 27, 2013

(54) VIBRATION SPEAKER WITH A SECURING DEVICE

(71) Applicants: Chien-Hsuan Yen, New Taipei City (TW); Chien-Chang Chen, Taoyuan County (TW)

(72) Inventors: Chien-Hsuan Yen, New Taipei City (TW); Chien-Chang Chen, Taoyuan County (TW)

(73) Assignee: CHIEF LAND ELECTRONIC CO., LTD., NEW TAIPEI CITY (TW)

(21) Appl. No.: 13/366,300

(22) Filed: Feb. 4, 2012

(30) Foreign Application Priority Data
Dec. 27, 2011 (TW) 100224699

(51) Int. Cl. H04R 1/00; H04R 17/00

(52) U.S. Cl. 381/190; 381/191

(57) ABSTRACT

The present invention is directed to a vibration speaker with a securing device. The vibration speaker includes at least one transducer. The vibration speaker is attached to a securing element, which includes a bottom plate, at least one lateral plate and at least one securing portion. A top surface of the bottom plate is in contact with a bottom surface of the vibration speaker; the lateral plate extends from an edge of the bottom plate, and is in contact with a side surface of the vibration speaker; and the securing portion fastens the vibration speaker.

### CROSS-REFERENCE TO RELATED APPLICATIONS

The entire contents of Taiwan Patent Application No. 100224699, filed on Dec. 27, 2011, from which this application claims priority, are incorporated herein by reference.

### BACKGROUND OF THE INVENTION

1. Field of the Invention

The present invention generally relates to a vibration speaker, and more particularly to a vibration speaker with a securing device.

2. Description of Related Art

A speaker (or “loudspeaker”) is a transducer that transforms an electrical signal to mechanical vibration. A conventional moving-coil speaker is made up of a magnet, a voice coil, a flexible support and a sound releasing hole. In operation, the electrical signal is transferred to the voice coil, which produces electromagnetic induction, therefore generating an induced current. The induced current energizes the flexible support, and sound is thus produced via the sound releasing hole. In spite of the fact that the conventional moving-coil speaker has been fully developed, it nevertheless occupies large volume, consumes great power and is liable to magnetic field. Therefore, the conventional moving-coil speaker is not adaptable to miniaturization or portability for electronic devices.

In order to overcome the disadvantages mentioned above, a vibration speaker is thus proposed. The vibration speaker produces sound according to acoustic resonance by propagating the generated vibration, energy to a vibration, plate that is in contact with the vibration speaker.

A conventional vibration speaker makes contact with the vibration plate by way of its weight, or forms a bond with the vibration, plate via an adhesive element that is fixed to the vibration speaker. However, a single adhesive element cannot be adapted to diverse vibration plates with varieties of materials (e.g., wood, glass or metal), smoothness and roughness. Further, as the adhesive element often times cannot be replaced with ease, its binding force dramatically decreases due to contamination after a couple of uses, therefore leading to ineffectiveness in secureness of the vibration speaker and cutting down the convenience provided by the vibration speaker.

Therefore, a need has arisen to propose a novel vibration speaker with a securing device to overcome the drawbacks discussed above.

### SUMMARY OF THE INVENTION

In view of the foregoing, the embodiment of the present invention provides a vibration speaker with a securing device, to which a user may flexibly replace a securing element and its composing material according to characteristics of the vibration plate. Accordingly, the vibration speaker may adaptively match diverse vibration plates, and effectiveness in secureness between the vibration speaker and the vibration plate may be greatly enhanced.

According to one embodiment, the embodiment includes a vibration speaker and a securing element. The vibration speaker has at least one transducer, and the vibration speaker is attached to the securing element. The securing element includes a bottom plate, at least one lateral plate and at least one securing portion. A top surface of the bottom plate is in contact with a bottom surface of the vibration speaker. The lateral plate extends from an edge of the bottom plate, and the lateral plate is in contact with a side surface of the vibration speaker. The securing portion is used to fasten the vibration speaker. According to a first embodiment, the securing portion extends from an edge of the lateral plate, said edge being not in contact with the bottom plate, such that a bottom surface of the securing portion is in contact with a top surface of the vibration speaker. According to a second embodiment, the securing portion includes an elongated protrusion disposed on an inner surface of the lateral plate, and a groove is disposed on a corresponding side surface of the vibration speaker, wherein the elongated protrusion has a shape complementary to the shape of the groove. According to a third embodiment, the securing element includes a hook disposed on a side surface of the vibration speaker, and a hole disposed on a corresponding outer surface of the lateral plate, wherein the hook and the hole are interlocked when the bottom surface of the vibration speaker is in contact with the top surface of the bottom plate.

### BRIEF DESCRIPTION OF THE DRAWINGS

FIG. 1A shows a perspective view of a vibration speaker with a securing device according to a first embodiment of the present invention;

FIG. 1B shows a perspective view of the vibration speaker being inserted into the securing element of FIG. 1A;

FIG. 2A shows a bottom perspective view of a securing element according to a modified first embodiment of the present invention;

FIG. 2B shows a partial cross section of the fastening element of FIG. 2A being inserted into the groove;

FIG. 3A to FIG. 3D show bottom views of varieties of grooves of the securing element according to the embodiment of the present invention;

FIG. 4A to FIG. 4C show cross-sectional views of varieties of grooves of the securing element according to the embodiment of the present invention;

FIG. 5A shows a perspective view of a vibration speaker with a securing device according to a second embodiment of the present invention;

FIG. 5B shows a perspective view of the vibration speaker being inserted into the securing element of FIG. 5A;

FIG. 6A shows a perspective view of a vibration speaker with a securing device according to a third embodiment of the present invention; and

FIG. 6B shows a perspective view of the vibration speaker being inserted into the securing element of FIG. 6A.

### DETAILED DESCRIPTION OF THE INVENTION

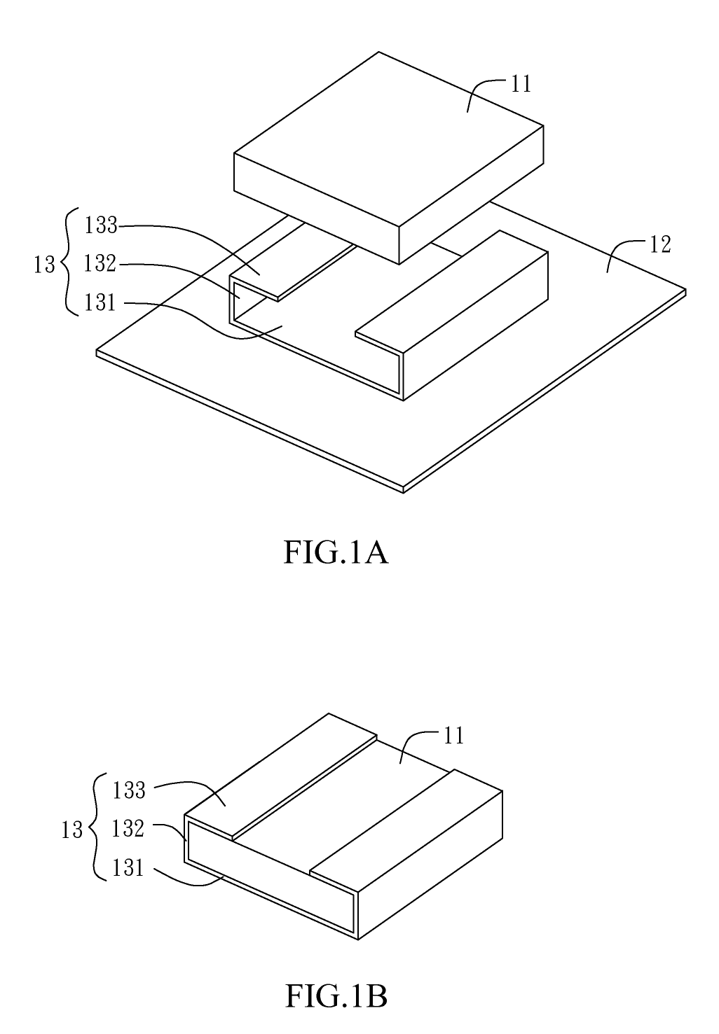

FIG. 1A shows a perspective view of a vibration speaker 11 with a securing device according to a first embodiment of the present invention. In the embodiment, the vibration speaker 11 includes a vibration module and a driving module. The driving module receives an electrical signal, according to which a proper driving signal is generated and is used to drive the vibration module, therefore resulting in mechanical vibration. When the mechanical vibration is transferred to a vibration plate 12 (e.g., a piece of glass, a desktop, or a wall), sound wave is produced and perceived by a user. The vibration module of the embodiment includes at least one transducer, which is made up of a piezoelectric material, an electro-active polymer (EAP), a shape memory alloy (SMA), a magnetostrictive material, an electrostrictive material, a voice coil motor, an eccentric rotating mass (ERM) motor, or a linear resonant actuator (LRA).

The present embodiment includes a securing element 13, to which the vibration speaker 11 may be attached. FIG. 1B shows a perspective view of the vibration speaker 11 being inserted into the securing element 13 of FIG. 1A. The securing element 13 of the embodiment includes a bottom plate 131, a lateral plate 132 and a securing portion 133. Specifically, a top surface of the bottom plate 131 is in contact with a bottom surface of the vibration speaker 11 to support the vibration speaker 11; the lateral plate 132 extends from an edge of the bottom plate 131, and is in contact with a side surface of the vibration speaker 11. The securing portion 133 of the embodiment extends from a lateral plate's 132 edge that is not in contact with the bottom plate 131, such that a bottom surface of the securing portion 133 is in contact with a top surface of the vibration speaker 11, thereby fastening the vibration speaker 11 in the securing element 13. When the bottom plate 131 of the securing element 13 is in contact with the vibration plate 12, the mechanical vibration generated by the vibration speaker 11 may be transferred to the vibration plate 12 via the bottom plate 131.

The bottom plate 131 of the embodiment may include an adhesive (e.g., polyurethane adhesive or PU adhesive), clay or a magnet. Accordingly, the bottom plate 131 of the securing element can be, e.g., magnetically or adhesively, fastened to the vibration plate 12, such that the vibration speaker 11 can be secured to the vibration plate 12.

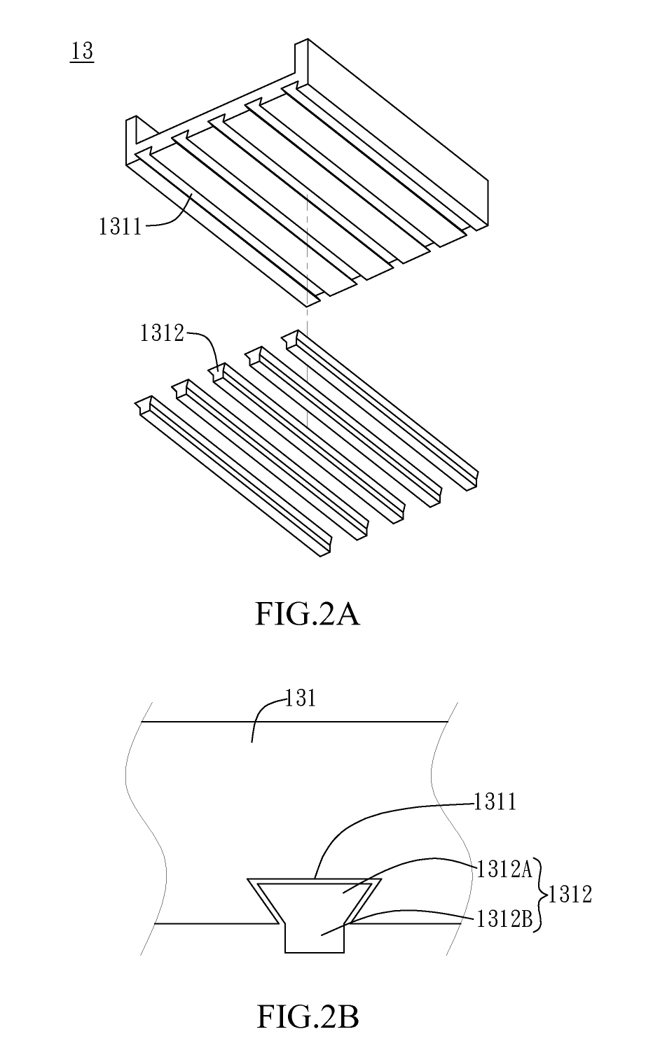

FIG. 2A shows a bottom perspective view of a securing element according to a modified first embodiment of the present invention. In the embodiment, the bottom plate 131 of the securing element 13 has at least one groove 1311. Further, the embodiment includes at least one fastening element 1312 corresponding to the at least one groove 1311. The fastening element 1312 is capable of being inserted into the groove 1311. The groove 1311 and the fastening element 1312 mentioned above together form a securing device, particularly a replaceable securing device, of the securing element 13.

FIG. 2B shows a partial cross section of the fastening element 1312 being inserted into the groove 1311. As shown in the figure, the fastening element 1312 includes an inserting portion 1312A and a fastening portion 1312B. The inserting portion 1312A is capable of being inserted inside the groove 1311, and the fastening portion 1312B is disposed outside the groove 1311. The fastening portion 1312B of the embodiment includes a fastening material for being fastened to the vibration plate 12, such that the vibration speaker 11 can be secured to the vibration plate 12 via the securing element 13. The fastening material may be, for example, an adhesive (e.g., polyurethane adhesive or PU adhesive), clay or a magnet.

In one embodiment, the fastening elements 1312 need not be made up of the same fastening material. In other words, the fastening elements 1312 of the securing device of the embodiment may respectively select different fastening materials to result in a combinatory securing device, which may adaptively match diverse vibration plates with varieties of materials, smoothness and roughness to arrive at a better effectiveness in securing the vibration speaker 11. For example, with respect to a metal vibration plate 12, the fastening elements 1312 either may all be made up of the magnet, or may partially be made up of the magnet and partially be made up of the adhesive. With respect to a non-metal vibration plate 12, the fastening elements 1312 may all be made up of the adhesive.

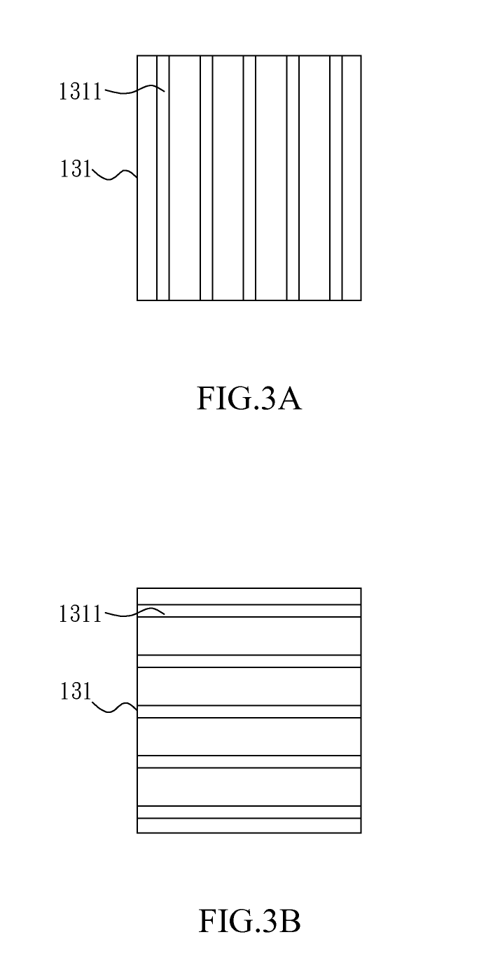

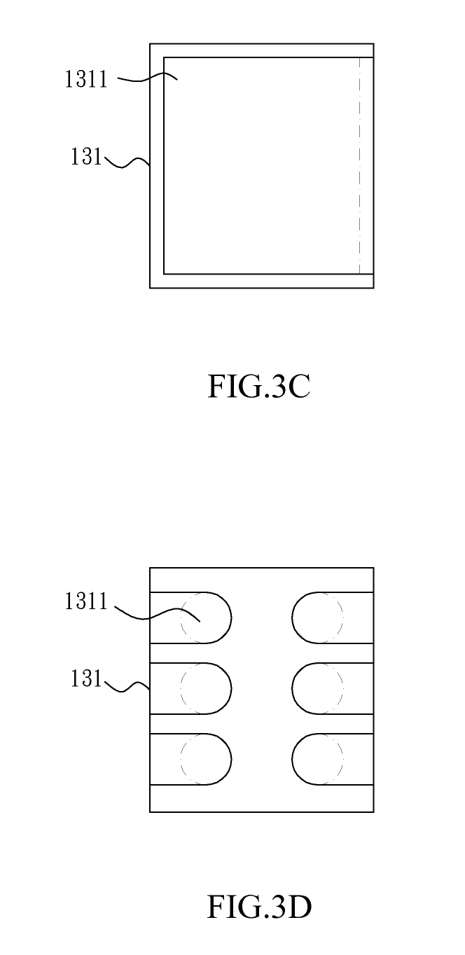

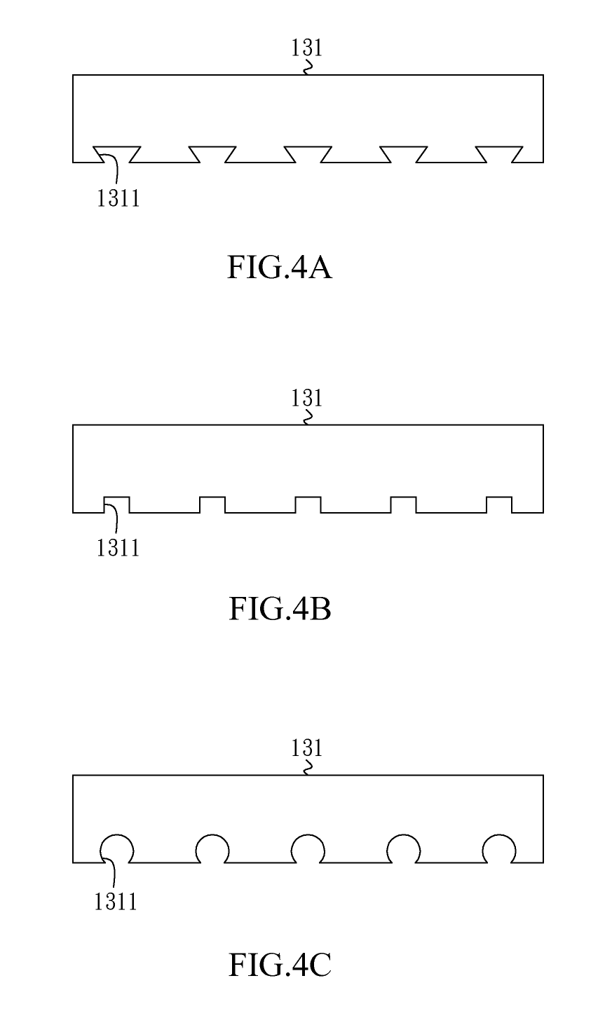

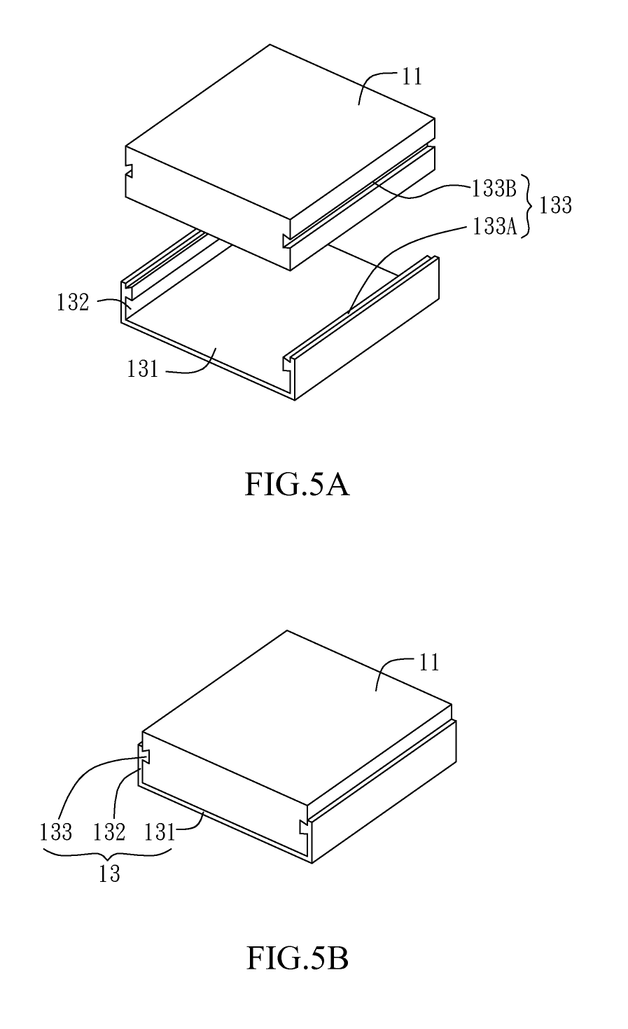

The groove 1311 of the securing element 13 in the embodiment may have a shape other than that shown in FIG. 2A. FIG. 3A to FIG. 3D show bottom views of varieties of grooves 1311 of the securing element 13 according to the embodiment of the present invention. Specifically, FIG. 3A shows the grooves 1311 of a (longitudinal) bar shape, FIG. 3B shows the grooves 1311 of a (lateral) bar shape, FIG. 3C shows the groove 1311 of a block shape, and FIG. 3D shows the grooves 1311 of a circular shape. As illustrated in FIG. 3C, an opening extends from the block-shape groove 1311 to an edge of the bottom pate 131 of the securing element 13. The extended opening facilitates inserting the fastening element 1312 to the groove 1311 or removing the fastening element 1312 from the groove 1311. Similarly, as illustrated in FIG. 3D, openings extend from the circular grooves 1311 to the edges of the bottom plate 131 of the securing element 13. FIG. 4A to FIG. 4C show cross-sectional views of varieties of grooves 1311 of the securing element 13 according to the embodiment of the present invention. Specifically, FIG. 4A shows the grooves 1311 with a trapezoidal cross section, FIG. 4B shows the grooves 1311 with a rectangular cross section, and FIG. 4C shows the grooves 1311 with a semi-circular cross section. In the embodiment, the inserting portion 1312A of the fastening element 1312 has a shape and cross section complementary to the shape and cross section of the groove 1311 as shown in FIGS. 3A-3D and FIGS. 4A-4C.

In one embodiment, the grooves 1311 or the fastening elements 1312 need not have the same shape. In other words, the grooves 1311 or the fastening elements 1312 of the embodiment may respectively select different shapes and configurations to adaptively match characteristics of the vibration plate 12.

FIG. 5A shows a perspective view of a vibration speaker 11 with a securing device according to a second embodiment of the present invention, and FIG. 5B shows a perspective view of the vibration speaker 11 being inserted into the securing element 13 of FIG. 5A. The present embodiment is similar to the first embodiment (FIG. 1A), with the exception that the securing portion 133 of the present embodiment includes an elongated protrusion 133A disposed on an inner surface of the lateral plate 132, and a groove 133B is disposed on a corresponding side surface of the vibration speaker 11, wherein the elongated protrusion 133A has a shape complementary to the shape of the groove 133B.

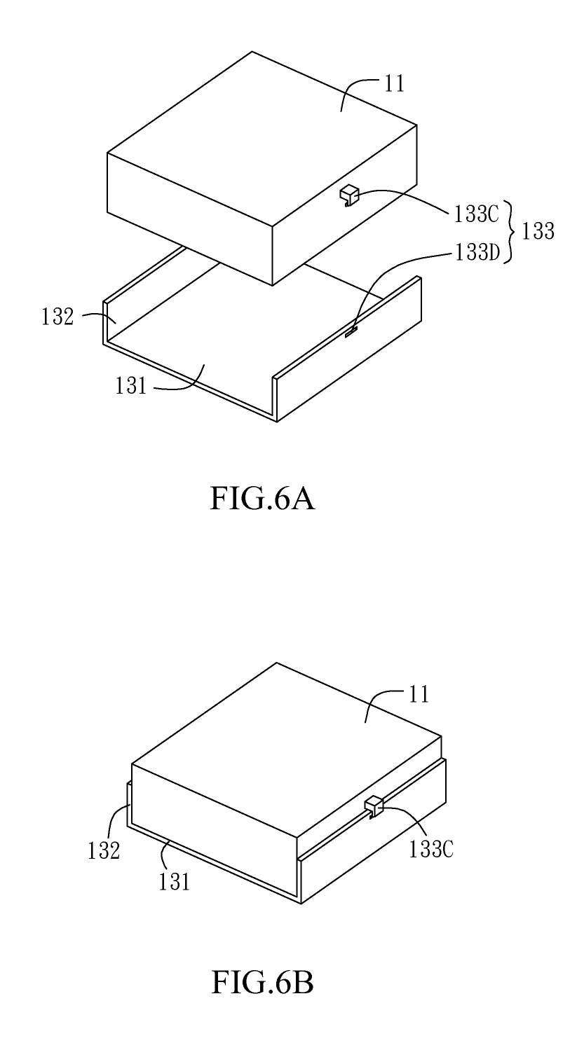

FIG. 6A shows a perspective view of a vibration speaker 11 with a securing device according to a third embodiment of the present invention, and FIG. 6B shows a perspective view of the vibration speaker 11 being inserted into the securing element 13 of FIG. 6A. The present embodiment is similar to the first embodiment (FIG. 1A), with the exception that the securing element 133 of the present embodiment includes a hook 133C disposed on a side surface of the vibration speaker 11, and a hole 133D disposed on a corresponding outer surface of the lateral plate 132, wherein the hook 133C and the hole 133D may be interlocked when the bottom surface of the vibration speaker 11 is in contact with the top surface of the bottom plate 131.

Although specific embodiments have been illustrated and described, it will be appreciated by those skilled in the art that various modifications may be made without departing from the scope of the present invention, which is intended to be limited solely by the appended claims.

What is claimed is:

1. A vibration speaker with a securing device, comprising:
a vibration speaker having at least one transducer; and
a securing element, to which the vibration speaker is attached, the securing element including:
a bottom plate, a top surface of which is in contact with a bottom surface of the vibration speaker;
at least one lateral plate extended from an edge of the bottom plate, the lateral plate being in contact with a side surface of the vibration speaker; and
at least one securing portion for fastening the vibration speaker.

2. The vibration speaker with the securing device of claim wherein the transducer comprises a piezoelectric material, an electro-active polymer (EAP), a shape memory alloy (SMA), a magnetostrictive material, an electrostrictive material, a voice coil motor, an eccentric rotating mass (ERM) motor, or a linear resonant actuator (LRA).

3. The vibration speaker with the securing device of claim wherein, the securing portion extends from an edge of the lateral plate, said edge being not in contact with the bottom plate, such that a bottom surface of the securing portion is in contact with a top surface of the vibration speaker.

4. The vibration speaker with the securing device of claim wherein the bottom plate comprises an adhesive, clay or a magnet, thereby fastening the bottom plate to a vibration plate.

5. The vibration speaker with the securing device of claim wherein a bottom of the bottom plate has at least one groove; and at least one fastening element, corresponding to the at least one groove, being capable of being inserted into the corresponding groove.

6. The vibration speaker with the securing device of claim 5, wherein the fastening element comprises an inserting portion and a fastening portion, wherein the inserting portion is capable of being inserted inside the groove, and the fastening portion is disposed outside the groove.

7. The vibration speaker with the securing device of claim 6, wherein the fastening portion comprises an adhesive, clay or a magnet.

8. The vibration speaker with the securing device of claim 6, wherein the groove has a shape complementary to a shape of the inserting portion of the fastening element.

9. The vibration speaker with the securing device of claim wherein the securing portion includes an elongated protrusion disposed on an inner surface of the lateral plate, and a groove is disposed on a corresponding side surface of the vibration speaker, wherein the elongated protrusion has a shape complementary to a shape of the groove.

10. The vibration speaker with the securing device of claim 1, wherein, the securing element includes a hook disposed on a side surface of the vibration speaker, and a hole disposed on a corresponding outer surface of the lateral plate, wherein the hook and the hole are interlocked when the bottom surface of the vibration speaker is in contact with the top surface of the bottom plate.
